(19) United States
(12) Patent Application Publication
(10) Pub. No.: US 2013/0017717 A1
(43) Pub. Date: Jan. 17, 2013

(54) COMPUTER POWER ON SELF TEST CARD

(71) Applicant: ZHAO-JIE CAO, Shenzhen City (CN)

(72) Inventor: ZHAO-JIE CAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/339,216

(22) Filed: Dec. 28, 2011

(30) Foreign Application Priority Data
Jul. 14, 2011 (CN) 201120248309.4

(51) Int. Cl. H01R 33/945

(52) U.S. Cl. 439/517

(57) ABSTRACT

A power on self test card includes a connector module, a logic unit, a microchip, and a display module. The connector module includes a first connector, a second connector, and a third connector. The connector module enables the power on self test card to electrically connect to different types of low pin count buses on various motherboards via either the first connector, the second connector, or the third connector.

### BACKGROUND

1. Technical Field

The present disclosure relates to power on self test (POST) cards, particular to a POST card which can electrically connect to computer motherboards with different interfaces.

2. Description of Related Art

Current POST cards typically have only one low pin count (LPC) bus and thus can only connect to computer motherboards that include an interface compatible with the LPC bus. However, there are many kinds of computer motherboards and not all may have an interface compatible with the bus on the POST card.

Therefore, there is room for improvement within the art.

### BRIEF DESCRIPTION OF THE DRAWINGS

Many aspects of the present disclosure can be better understood with reference to the following drawings. The elements in the drawings are not necessarily drawn to scale, the emphasis instead being placed upon clearly illustrating the principles of the disclosure.

The FIGURE is a block diagram of a POST card according to an embodiment.

### DETAILED DESCRIPTION

In general, the word “module” as used herein, refers to logic embodied in hardware or firmware, or to a collection of detect module instructions, written in a programming language, such as, for example, Java, C, or in assembly. One or more detect module instructions in the module may be embedded in firmware, such as in an EPROM. It will be appreciated that a module may comprise connected logic units, such as gates and flip-flops, and may comprise programmable units, such as programmable gate arrays or processors. The modules described herein may be implemented as either detect module and/or hardware module and may be stored in any type of computing system-readable medium or other computing system storage device.

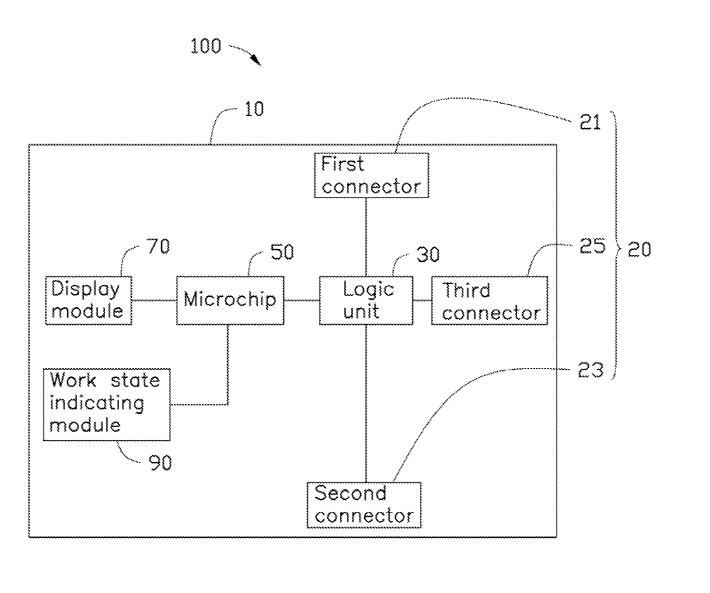

FIG. 1 is a block diagram of a POST card according to an embodiment. The POST card 100 includes a card body 10, a connector module 20, a logic unit 30, a microchip 50, a display module 70, and a work state indicating module 90. The connector module 20, the logic unit 30, the microchip 50, the display module 70, and the indicating module 90 are mounted on the card body 10. Both the connector module 20 and the microchip 50 are electrically connected to the logic unit 30. Both the display module 70 and the indicating module 90 are electrically connected to the microchip 50.

The connector module 20 is configured for connecting the POST card 100 to an LPC bus on a computer motherboard (not shown) to run a diagnostic check on the POST card. The connector module 20 is configured as universal connectors that can be used with any motherboard having an LPC bus. The connector module 20 includes a first connector 21, a second connector 23, and a third connector 25. The first connector 21, the second connector 23, and the third connector 25 are electrically connected to the logic unit 30, configured to enable the POST card 100 to electrically connect to a computer motherboard with different LPC buses. In the exemplary embodiment, both the first connector 21 and the second connector 23 are universal pin connector with different specified pin spacing and/or pin order, and the pin spacing of the first connector 21 is 2.54 mm, the pin spacing of the second connector 23 is 2.00 mm. The third connector 25 is a USB connector or a universal pin connector which is different from the first connector 21 and the second connector 23 in pin spacing and/or pin order, electrically connected to a motherboard by a suitable transmission line. As such, the connector module 20 can be directly connected to a computer motherboard with an interface compatible with either the first connector 21 or the second connector 23, and for motherboards not compatible with the connectors 21, 23 the module 20 can be connected via the third connector 25 and a suitable transmission line, for example, a coaxial-cable or a USB data line. Thus, the connector module 20 is an universal connector for LPC bus connections.

In the exemplary embodiment, the first connector 21 and the second connector 23 are positioned on opposite edges of the card body 10. In use, the POST card 100 can be connected to a computer motherboard via the first connector 21, or the card body 10 rotated and the second connector 23 used.

The logic unit 30 is configured to read a diagnostic signal generated by the computer motherboard which is connected to the connector module 20 during a boot up sequence of the computer motherboard, and then transmit the signal to the microchip 50.

The microchip 50 is programmed to diagnose problems with the computer motherboard and provide diagnostic codes accordingly. The microchip 50 pre-stores different kinds of POST codes and character information corresponding to the POST codes from different companies, for example, PHOENIX, AMI, AWARD, and so on. The microchip 50 is programmed to translate the signals from the motherboards to POST codes, and compare the translated POST codes to the pre-stored POST codes in the microchip 50, to find corresponding character information. The microchip 50 sends the translated POST codes and corresponding character information to the display module 70, to display the diagnostic results.

In the exemplary embodiment, the logic unit 30 can receive diagnostic signal from three different address-ports, for example, port 80, port 84, port 85, and so on. Thereafter, when the diagnostic signal is too large to transmit through a single address-port, the POST card 100 can use three address-ports at the same time.

In addition, the microchip 50 can detect whether the POST card 10 is connected to a motherboard via the first connector 21 or the second connector 23, and adjust how information is displayed on the display 70 accordingly for the convenience of the user.

In the exemplary embodiment, the display module 70 includes four display units. Three of the display units are mounted on one surface of the card board 10, to display diagnostic results from the three address-ports. The other display unit is mounted on the opposite surface of the card board 10, to display diagnostic results from any address-port. Thus, the diagnostic results can be read from either side of the card board 10.

The indicating module 90 may comprise three indicator lights such as a red, a green, and a yellow light. As an example, in this embodiment, a red light indicates the POST card 100 is on, green indicates the POST card 100 is performing diagnostic testing, and yellow indicates the POST card 100 clearing and resetting for next test.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A power on self test card, comprising:
a connector module comprising a first connector, a second connector, and a third connector, the first connector, the second connector, and the third connector having different structures, pin spacing and/or pin order, configured to electrically connect the power on self test card to computer motherboards with different low pin count buses;
a logic unit electrically connected to the first connector, the second connector, and the third connector, configured to read a diagnostic signal from a computer motherboard connected to the power on self test card during a boot up sequence of the computer motherboard;
a microchip pre-storing power on self test (POST) codes and character information corresponding to the pre-stored POST codes, the microchip configured for translating the diagnostic signal to POST codes and finding character information corresponding to the translated POST codes by comparing the translated POST codes with the pre-stored POST codes; and
a display module configured to display the translated POST codes and character information corresponding to the translated POST codes.

2. The power on self test card of claim 1, wherein the first connector is a universal pin connector with 2.54 mm spacing between each pin.

3. The power on self test card of claim 1, wherein the second connector is a universal pin connector with 2.00 mm spacing between each pin.

4. The power on self test card of claim 1, wherein the third connector is a USB connector or a universal pin connector different from the first connector and the second connector in pin spacing and/or pin order, the third connector electrically connects to motherboard through a transmission line compatible with both the third connector and the low pin count buses on the motherboard.

5. The power on self test card of claim 1, further comprising a card body supporting the connector module, the logic unit, the microchip and the display module, wherein the first connector and the second connector are positioned on opposite edges of the card body, the microchip detects the power on self test card connecting to motherboard via the first connector or the second connector, rotates the translated POST codes and corresponding character information 180 degrees, and adjusts how information is displayed on the display module accordingly.

6. The power on self test card of claim 1, wherein the logic unit receives diagnostic signals from three different address-ports of the motherboard at the same time, the display module comprises at least three display units, each display unit configured to display translated POST codes and corresponding character information from an address-port of the motherboard.

7. The power on self test card of claim 1, further comprising a work state indicating module configured to indicate different work states of the power on self test card.

8. The power on self test card of claim 7, wherein the work state indicating module indicates different work states of the power on self test card using different colored lights.
